(19) United States
(12) Patent Application Publication
(10) Pub. No.: US 2007/0232317 A1
(43) Pub. Date: Oct. 4, 2007

(54) Method of assigning a tracking area to mobile unit based on a location update frequency

(76) Inventors: Alessio Casati, Swindon (GB); Sudeep Palat, Swindon (GB); Said Tatesh, Swindon (GB)

Correspondence Address: WILLIAMS, MORGAN & AMERSON, 10333 RICHMOND, SUITE 1100, HOUSTON, TX, 77042, US

(21) Appl. No.: 11/391,717

(22) Filed: Mar. 28, 2006

(51) Int. Cl. H04Q 7/20

(52) U.S. Cl. 455/450; 455/456.1

(57) ABSTRACT

The present invention provides a method for determining a tracking area associated with a mobile unit based on a location update frequency. The method includes determining, at a mobile unit, a tracking area associated with the mobile unit based on a location update frequency.

### BACKGROUND OF THE INVENTION

1. Field of the Invention

This invention relates generally to communication systems, and, more particularly, to wireless communication systems.

2. Description of the Related Art

The coverage area of a wireless communication system is typically divided into a number of cells, which may be grouped into one or more networks. Mobile units located in each cell may access the wireless communications system by establishing a wireless communication link, often referred to as an air interface, with a base station associated with the cell. The mobile units may include devices such as mobile telephones, personal data assistants, smart phones, Global Positioning System devices, wireless network interface cards, desktop or laptop computers, and the like. As a mobile unit moves between cells in the wireless communication system, the mobile unit may periodically provide location update messages that inform the wireless communication system of the mobile unit's current location. The wireless communication system may use the information in the location update messages to direct information to the mobile unit via the last serving base station indicated in the most recent location update message.

In some activity states, such as the idle or dormant mode or when the mobile unit has been powered down, the mobile unit may stop sending location update messages even though it may continue to move through the cells in the wireless communication system, until some condition is met (e.g., when the mobile unit crosses the boundary of the tracking area associated with the last location update message, a new location update with the new tracking area is sent). Accordingly, the wireless communication system may not know the exact cell that includes the mobile unit when information becomes available for delivery to the mobile unit. The wireless communication system may attempt to reach the mobile unit by sending paging messages over a plurality of cells belonging to a paging area determined by the network based on the information it has about the last known mobile unit location. For example, the wireless communication system may attempt to reach the mobile unit by sending paging messages to the cells belonging to the last known tracking area.

The paging messages contain information that indicates to the mobile unit that information is available for transmission to the mobile unit. If the mobile unit receives the paging message, it may provide a paging response via a base station that provides wireless connectivity to the cell that includes the base station. The paging response typically indicates that the mobile unit is available to receive the information and may also provide information indicating how to route the information to the mobile unit.

Both the paging messages and the location update messages represent system overhead. Accordingly, the wireless communication system is generally designed to meet two conflicting objectives: reducing the overhead from the paging load and reducing the number of location update messages transmitted by the mobile unit. The paging load is typically minimized when the location of the mobile unit is known with relatively high accuracy so that each paging message can be transmitted to a relatively smaller number of cells. However, increasing the accuracy of the location of the mobile unit requires transmitting a larger number of location update messages. In contrast, reducing the number of location update messages transmitted by the mobile unit may reduce the accuracy of the location information used by the wireless communication system to locate the mobile unit, which typically results in each paging message being transmitted to a relatively large number of cells.

The conventional solution to this problem is to define tracking areas that include the cells serviced by a plurality of base stations. The mobile units may then transmit location update messages when they cross from one tracking area to another tracking area and the wireless communication system may begin the paging process by providing paging messages via the base stations in the tracking area indicated by the most recently received location update message. For example, the geographic area served by the wireless communication system may be divided up into multiple tracking areas that encompass the cells serviced by groups of 10 base stations. Mobile units in the wireless communication system may then provide location updates when they cross a cell boundary between the groups of 10 base stations and the wireless communication system may provide paging messages via the groups of 10 base stations in the tracking areas.

Conventional tracking areas may be static, i.e., the association of tracking areas to base stations remains constant over time, or dynamic, i.e., the wireless communication system may modify the tracking areas associated with a mobile unit. For example, an entity, such as a radio network controller, in a wireless communication system that implements dynamic modification of the tracking areas may determine a distance that the mobile unit has traveled between successive location update messages. If the mobile unit has moved a relatively large distance, the radio network controller may increase the size of the tracking area associated with the mobile unit to include a larger number of base stations. Conversely, if the mobile unit has moved a relatively small distance, the radio network controller may decrease the size of the tracking area. Conventional wireless communication systems may also dynamically adjust the size of tracking areas based on a velocity of the mobile unit.

Implementing static tracking areas and accounting for movement of the mobile units through these tracking areas using entities in the wireless communication system, e.g., in a radio network controller, increases the computational load in the wireless communication system. The computational load may be further increased if the tracking areas are dynamically assigned by the wireless communication system, at least in part because the algorithms for assigning and/or modifying tracking areas associated with each mobile unit are computationally much more complex than the algorithms used to implement static tracking areas. For example, each radio network controller may need to acquire, store, and manipulate information indicating at least the current and previous locations of each mobile unit served by the radio network controller, as well as the size and/or constituent base stations of the tracking areas associated with each mobile unit served by the radio network controller.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for determining a tracking area associated with a mobile unit based on a location update frequency. The method includes determining, at a mobile unit, a tracking area associated with the mobile unit based on a location update frequency.

In another embodiment of the present invention, a method is provided for assigning a tracking area to a mobile unit based on a location update frequency. The method includes receiving information indicative of a tracking area associated with a mobile unit in response to determining, at the mobile unit, the tracking area associated with the mobile unit based on a location update frequency.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a first exemplary embodiment of a wireless communication system, in accordance with the present invention;

FIG. 2 shows a plot of a location update frequency of a mobile unit as a function of time, in accordance with the present invention;

FIG. 3 conceptually illustrates a second exemplary embodiment of a wireless communication system, in accordance with the present invention; and

FIG. 4 conceptually illustrates one exemplary embodiment of a method of assigning tracking areas to mobile units, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

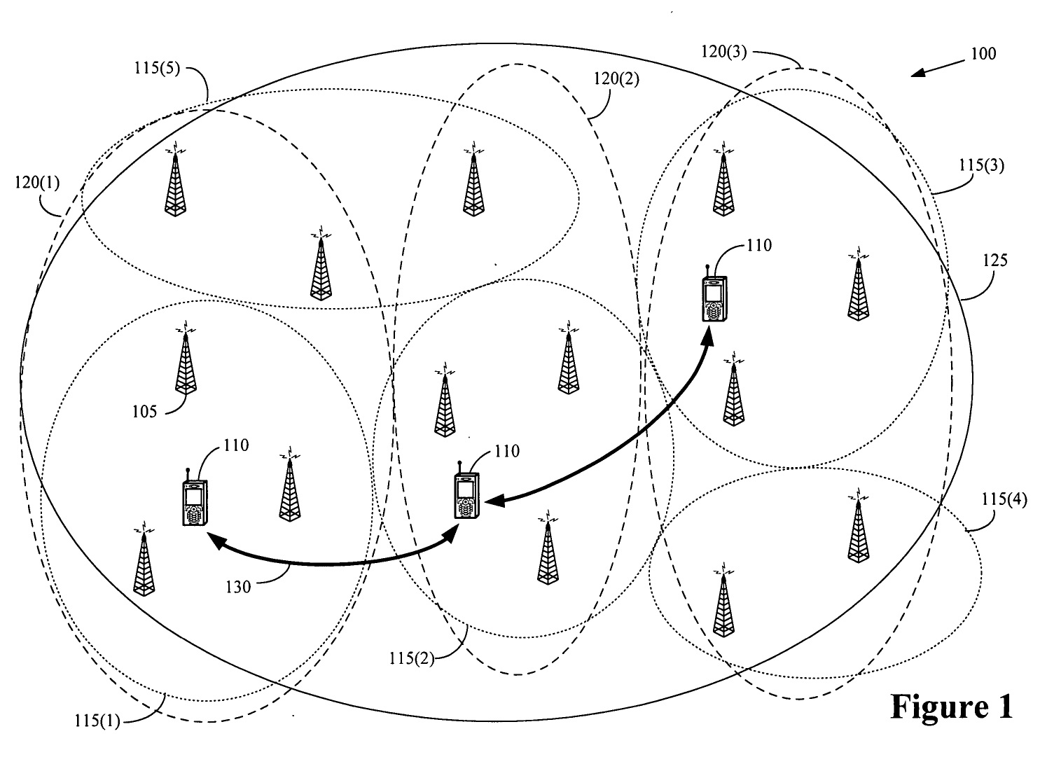

FIG. 1 conceptually illustrates a first exemplary embodiment of a wireless communication system 100. In the illustrated embodiment, a plurality of base stations 105 (only one indicated in FIG. 1) provide wireless connectivity to a corresponding plurality of geographic areas or cells (not shown). Although base stations 105 are used to provide wireless connectivity in the first exemplary embodiment of the wireless communication system 100, persons of ordinary skill in the art having benefit of the present disclosure should appreciate that the present invention is not limited to base stations 105. In alternative embodiments, base station routers, access networks, and the like may also be used to provide wireless connectivity. Furthermore, the base stations 105 (or other entities used to provide wireless connectivity) may operate according to any wireless communication protocol. Exemplary wireless communication protocols may include, but are not limited to, Code Division Multiple Access (CDMA, CDMA 2000), Frequency Division Multiple Access (FDMA), Orthogonal Frequency Division Multiple Access (OFDMA), protocols defined by the Universal Mobile Telecommunication System (UMTS) standards, protocols defined according to one or more of the IEEE 802 standards, and the like. The particular wireless communication protocol, or combination of protocols, is a matter of design choice and not material to the present invention.

The base stations 105 may provide wireless connectivity to one or more mobile units 110. In the interest of clarity, a single mobile unit 110 is depicted in FIG. 1. However, persons of ordinary skill in the art having benefit of the present disclosure should appreciate that any number of mobile units 110 may be deployed in the geographic areas served by the wireless communication system 100. Exemplary mobile units may include, but are not limited to, cellular telephones, personal data assistants, smart phones, pagers, text messaging devices, network interface cards, notebook computers, desktop computers, and the like. As used herein, the terms “wireless communication system” and/or “wireless communication network” will be understood to refer to the base stations 105 and any other entities or devices that may be used to provide wireless connectivity to the mobile units 110. However, the mobile units 110 will be understood to be distinct and separate from the wireless communication system 100.

The base stations 105 are grouped into tracking areas 115(1-5), 120(1-3), 125 that include the geographic areas served by the constituent base stations 105. The indices (1-5) and (1-3) may be dropped when referring to the tracking areas 115, 120, 125 collectively. However, these indices may be used to indicate individual tracking areas 115, 120, 125 or subsets thereof. This convention may also be applied to other groups of elements indicated by a single number and an associated plurality of indices. In the illustrated embodiment, the tracking areas 115, 120, 125 are organized in a hierarchical fashion such that the tracking areas 115 include a relatively small number of base stations 105, the tracking areas 120 include a relatively larger number of base stations 105 than the tracking areas 115, and the tracking areas 125 include a relatively larger number of base stations 105 than the tracking areas 120. In some embodiments, the tracking areas 115, 120, 125 may provide wireless connectivity to progressively larger geographical areas via the progressively larger numbers of base stations 105. However, this may not always be the case, at least in part because the geographical areas served by different base stations 105 may vary based on numerous factors known to persons of ordinary skill in the art.

The mobile unit 110 is assigned to one of the tracking areas 115, 120, 125. In the illustrated embodiment, the mobile unit is initially assigned to the tracking area 115(1). Accordingly, the wireless communication system 100, or an entity therein such as a radio network controller (not shown), may attempt to locate the mobile unit 110 by providing one or more paging messages via the base stations 105 located within the tracking area 115(1). As used herein, the term “paging message” will be understood to refer to any message transmitted to the mobile unit 110 to indicate that the wireless communication system 100 would like to establish communications with the mobile unit 110.

The mobile unit 110 may roam from the initial tracking area 115(1) into other tracking areas such as the tracking area 115(2), as indicated by the arrow 130. In one embodiment, the mobile unit 110 may be configured to provide a location update message when the mobile unit 110 crosses a boundary between the initial tracking area 115(1) and the tracking area 115(2). Some wireless communication protocols define a particular Location Update message having a particular format and including certain predetermined types of information. However, as used herein, the term “location update message” will be understood to refer to any message transmitted by the mobile unit 110 that contains information that may be used, e.g., by the wireless communication system 100, to determine a location of the mobile unit 110. For example, the wireless communication system 100 may use the location update message to determine that the mobile unit 110 is in the tracking area 115(2).

The mobile unit 110 may determine a location update frequency as it roams through the wireless communication system 100. In one embodiment, the mobile unit 110 may include a timer (not shown) that comes down (or counts up) for a predetermined time period. The mobile unit 110 may then count the number of location update messages transmitted while a timer is counting down (or counting up). The location update frequency may then be determined by dividing the total number of location update messages by the predetermined time period. For example, if the predetermined time period is approximately 1 minute and 10 location update messages are transmitted during that time, then the location update frequency is approximately 10 per minute.

The mobile unit 110 is configured to determine or select a tracking area 115, 120, 125 based on the location update frequency determined by the mobile unit 110. In one embodiment, the mobile unit 110 may be assigned to one of the small tracking areas 115. However, the mobile unit 110 may determine that the location update frequency is above a selected threshold level and may therefore determine that it should be assigned to one of the relatively larger tracking areas 120, as will be discussed in detail below. The wireless communication system 100 may then assign the mobile unit 110 to the tracking area 120(2) based on information provided by the mobile unit 110. If the mobile unit 110 subsequently determines that the location update frequency has fallen below another selected threshold level, the mobile unit 110 may request reassignment to a smaller tracking area 115. However, if the location update frequency remains high (or increases) the mobile unit 110 may request assignment to a yet larger tracking area 125.

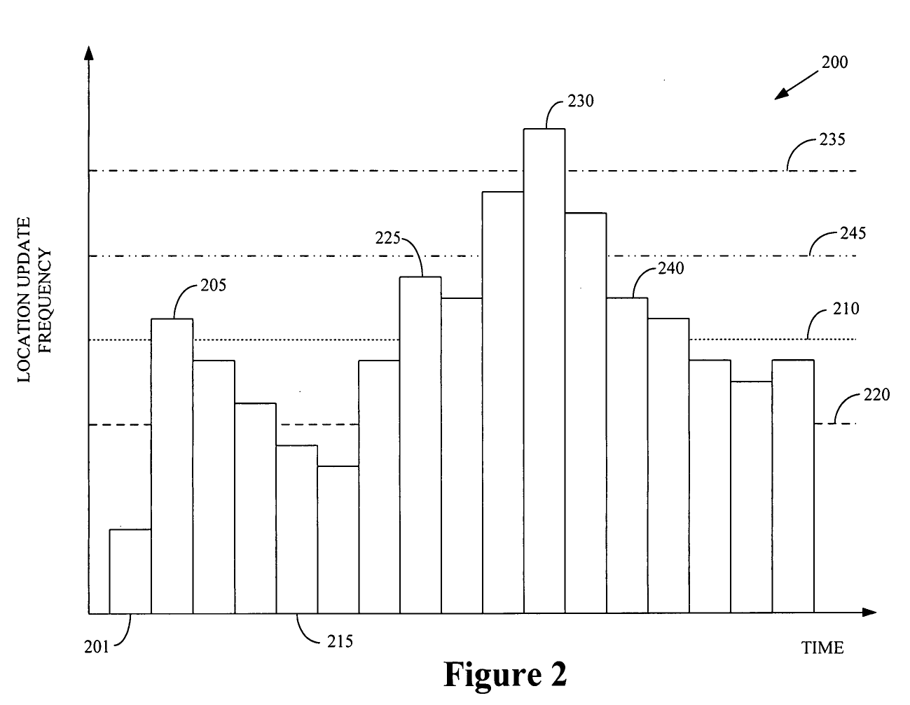

FIG. 2 shows a plot 200 of a location update frequency of a mobile unit as a function of time. The horizontal axis of the plot 200 indicates an elapsed time and the vertical axis indicates the location update frequency determined by the mobile unit for a selected period of time. In the illustrated embodiment, the selected period of time remains constant over the time period depicted in FIG. 2. However, persons of ordinary skill in the art having benefit of the present disclosure should appreciate that any time period, including a variable time period, may be selected. The units of the elapsed time and the location update frequency are arbitrary and not material to the present invention.

In the illustrated embodiment, the mobile unit is initially assigned to a tracking area having a relatively small number of the base stations. For example, the mobile unit may be assigned to a tracking area including approximately 10 base stations. This size of tracking area may be referred to as a Tier 1 tracking area. As discussed above, the mobile unit determines the number of location update messages transmitted during each selected time period. In the first time period bin 201, the location update frequency determined by the mobile unit is relatively low and the mobile unit takes no action in response to determining the location update frequency for the bin 201. The mobile unit may then determine a location update frequency for the second time period bin 205 and may also determine that this location update frequency exceeds a threshold level 210.

The mobile unit may determine that it should be assigned to a tracking area associated with a larger number of base stations in response to determining that the location update frequency exceeds the threshold level 210. The mobile unit may therefore provide information, such as a message indicating selection of the larger tracking area, to the wireless communication system, which may assign the mobile unit to a tracking area associated with a larger number of base stations. For example, the wireless communication system may assign the mobile unit to a tracking area including 50 base stations. This size of tracking area may be referred to as a Tier 2 tracking area. In one embodiment, the wireless communication system may perform any actions that may be required to assign the mobile unit to the Tier 2 tracking area, such as updating or establishing databases, communication pathways, location information, paging information, and the like. Furthermore, the wireless communication system may provide a message to the mobile unit that indicates that the mobile unit has been assigned to the Tier 2 tracking area.

In the illustrated embodiment, the mobile unit continues to determine location update frequencies in subsequent time period bins. The mobile unit determines that the location update frequency in the time period bin 215 has dropped below the threshold 220. The mobile unit may therefore determine that it should be assigned to a smaller tracking area, such as a Tier 1 tracking area. The mobile unit may therefore provide information, such as a message indicating selection of the smaller tracking area, to the wireless communication system, which may assign the mobile unit to a Tier I tracking area associated with a smaller number of base stations. In the illustrated embodiment, the threshold 210 is larger than the threshold 220, which may provide a hysteresis in the tracking area assignment algorithm. Persons of ordinary skill in the art having benefit of the present disclosure should appreciate that the difference between the thresholds 210, 220 is a matter of design choice and not material to the present invention. Furthermore, the thresholds 210, 220 may be equal in some embodiments.

Measurements of the location update frequency in the time period bin 225 indicate that the location update frequency has again exceeded the threshold 210, which causes the mobile unit to be assigned to a larger tracking area, such as a Tier 2 tracking area. Measurements of the location update frequency in the time period bin 230 indicate that the location update frequency has exceeded a threshold 235, which causes the mobile unit to be assigned to a yet larger tracking area. For example, the mobile units may be assigned to a Tier 3 tracking area including approximately 100 base stations. Although the threshold 235 is larger than the threshold 210, this is not necessary for the practice of the present invention. Measurements of the location update frequency in the time period bin 240 indicate that the location update frequency has dropped below a threshold 245, which causes the mobile unit to be assigned to a smaller tracking area, such as a Tier 2 tracking area. As discussed above, the thresholds 235, 245 may be given different values to provide a hysteresis in the tracking area assignment algorithm.

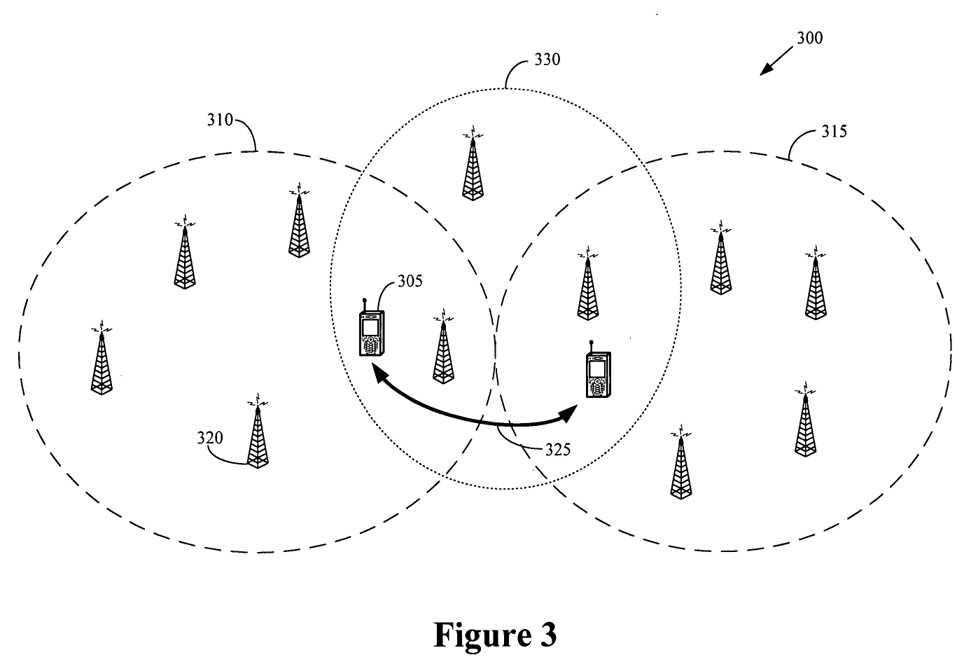

FIG. 3 conceptually illustrates a second exemplary embodiment of a wireless communication system 300. In the illustrated embodiment, a mobile unit 305 is roaming near a boundary between two tracking areas 310, 315 that include a relatively large number of base stations 320 (only one indicated in FIG. 3). Each time the mobile unit 305 crosses the boundary, as indicated by the arrow 325, the mobile unit 305 may transmit a location update message. If the frequency of the location update message transmissions is large enough, the mobile unit 305 may determine that it is desirable to assign the mobile unit 305 to a different tracking area. However, in the illustrated embodiment, the tracking areas 310, 315 may be the largest available tracking areas in the wireless communication system 300. Accordingly, the mobile unit 305 and/or the wireless communication system 300 may not be able to assign the mobile unit 305 to a larger tracking area including more base stations.

The mobile unit 305 may instead select a tracking area 330 that includes a relatively smaller number of base stations 320 than the tracking areas 310, 315. However, the tracking area 330 may encompass a portion of the boundary between the tracking areas 310, 315 proximate the mobile units 305. The wireless communication system 300 may then assign the period mobile units 305 to the tracking area 330. Since the tracking area 330 approximately encompasses the area in which the mobile unit 305 is roaming, the location update frequency determined by the mobile unit 305 may be reduced, which may reduce overall system overhead.

In one embodiment, the mobile unit 305 and/or the wireless communication system 300 may determine that the relatively large location update frequency determined by the mobile unit 305 is a consequence of the proximity of the mobile unit 305 to the boundary between the tracking areas 310, 315. For example, if the location update frequency increases relative to previous location update frequencies, then the mobile unit 305 and/or the wireless communication system 300 may determine that the mobile unit 305 is near the boundary between the tracking areas 310, 315. However, if the location update frequency of the mobile unit 305 remains relatively constant, then the mobile units 305 and/or the wireless communication system 300 may determine that the observed location update frequency is caused by movement of the mobile unit 305 across numerous tracking areas including the tracking areas 310, 315.

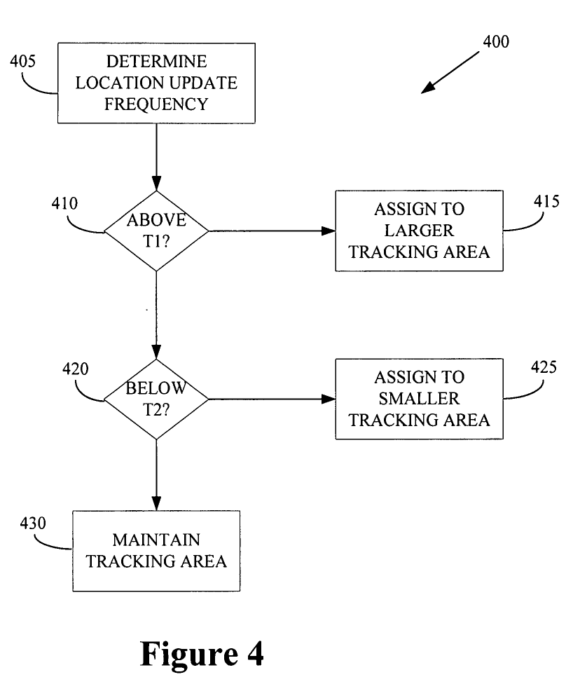

FIG. 4 conceptually illustrates one exemplary embodiment of a method 400 of assigning tracking areas to mobile units. In the illustrated embodiment, a mobile unit may determine (at 405) a location update frequency. The mobile unit may then determine (at 410) whether or not the location update frequency is above a first threshold value (T1). If the location update frequency is above the first threshold value, and the mobile unit may request assignment to a larger tracking area and a wireless communication system may assign (at 415) the mobile unit to the larger tracking area. However, if the location update frequency is not above the first threshold value, the mobile unit may determine (at 420) whether or not the location update frequency is below a second threshold value (T2). If the location update frequency is below the second threshold value, the mobile unit may request and be assigned (at 425) to a smaller tracking area. If the location update frequency is not below the second threshold value, the mobile unit may remain (at 430) in the current tracking area.

Embodiments of the techniques described above may have a number of advantages over conventional practice. For example, conventional wireless communication systems may determine whether or not to reassign a tracking area at an entity within the wireless communication system. In contrast, the techniques described above permit tracking area assignment and/or reassignment to be initiated at a mobile unit based upon location update frequencies. Accordingly, the mobile units may implement tracking area assignment algorithms independent of the wireless communication system. Embodiments of the techniques described above may also reduce the computational complexity required to implement tracking area reassignment on the wireless communication network side, as well as reduce both location update signaling load and paging signaling load.

Furthermore, by tuning the parameters in the computation of the moving average and the thresholds, e.g., using parameters provided by the network such as threshold values and timer durations, it is possible to cause mobile units to select upper (or lower) tier tracking areas faster or more slowly. For example, when there is a lot of location update traffic in one region of the network, the network may tune the parameters dynamically to cause mobile units to select upper tier tracking areas. Alternatively, when paging load is the issue, the network may tune the parameters dynamically to cause mobile units to stay at lower tracking are tiers.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
determining, at a mobile unit, a tracking area associated with the mobile unit based on a location update frequency.

2. The method of claim 1, comprising determining, at the mobile unit, the location update frequency.

3. The method of claim 2, wherein determining the tracking area comprises increasing a number of base stations included in the tracking area associated with the mobile unit in response to determining that the location update frequency has increased.

4. The method of claim 3, wherein the mobile unit is associated with a first tracking area, and increasing the number of base stations included in the tracking area associated with the mobile unit comprises selecting a second tracking area associated with a larger number of base stations than the first tracking area.

5. The method of claim 3, wherein determining that the location update frequency has increased comprises determining that the location update frequency exceeds a predetermined threshold value.

6. The method of claim 2, wherein determining the tracking area comprises decreasing a number of base stations included in the tracking area associated with the mobile unit in response to determining that the location update frequency has decreased.

7. The method of claim 6, wherein the mobile unit is associated with a first tracking area, and decreasing the number of base stations included in the tracking area associated with the mobile unit comprises selecting a second tracking area associated with a smaller number of base stations than the first tracking area.

8. The method of claim 6, wherein determining that the location update frequency has decreased comprises determining that the location update frequency is below a predetermined threshold value.

9. The method of claim 2, wherein determining the tracking area comprises decreasing a number of base stations included in the tracking area associated with the mobile unit in response to determining that the location update frequency has increased and in response to determining that the mobile unit is proximate a boundary of the tracking area.

10. The method of claim 9, wherein determining that the mobile unit is proximate the boundary of the tracking area comprises determining that the mobile unit is proximate the boundary of the tracking area based on a change in the location update frequency.

11. The method of claim 9, wherein the mobile unit is associated with a first tracking area, and wherein decreasing the number of base stations included in the tracking area comprises selecting a second tracking area having a smaller number of base stations than the first tracking area.

12. The method of claim 11, wherein selecting the second tracking area comprises selecting the second tracking area such that the second tracking area includes a portion of the first tracking area and a portion of a third tracking area, a boundary between the first and third tracking areas being within the second tracking area.

13. The method of claim 1, comprising receiving information indicative of at least one of a threshold value and a timer duration.

14. The method of claim 1, comprising providing information indicative of the determined tracking area.

15. A method, comprising:
receiving information indicative of a tracking area associated with a mobile unit in response to determining, at the mobile unit, the tracking area associated with the mobile unit based on a location update frequency.

16. The method of claim 15, wherein receiving the information indicative of the tracking area comprises receiving information indicative of an increased number of base stations included in the tracking area associated with the mobile unit in response to determining that the location update frequency has increased.

17. The method of claim 16, wherein the mobile unit is associated with a first tracking area, and receiving the information indicative of the tracking area comprises receiving information indicating selection of a second tracking area associated with a larger number of base stations than the first tracking area.

18. The method of claim 15, wherein receiving the information indicative of the tracking area comprises receiving information indicative of a decreased number of base stations included in the tracking area associated with the mobile unit in response to determining that the location update frequency has decreased.

19. The method of claim 18, wherein the mobile unit is associated with a first tracking area, and receiving the information indicative of the decreased number of base stations included in the tracking area associated with the mobile unit comprises receiving information indicative of selection of a second tracking area associated with a smaller number of base stations than the first tracking area.

20. The method of claim 15, wherein receiving the information indicative of the tracking area comprises receiving information indicative of a decreased number of base stations included in the tracking area associated with the mobile unit in response to determining that the location update frequency has increased and in response to determining that the mobile unit is proximate a boundary of the tracking area.

21. The method of claim 20, wherein the mobile unit is associated with a first tracking area, and wherein receiving the information indicative of the decreased number of base stations included in the tracking area comprises receiving information indicative of selection of a second tracking area having a smaller number of base stations than the first tracking area.

22. The method of claim 21, wherein receiving information indicative of selection of the second tracking area comprises receiving information indicative of selection of the second tracking area such that the second tracking area includes a portion of the first tracking area and a portion of a third tracking area, a boundary between the first and third tracking areas being within the second tracking area.

23. The method of claim 15, comprising assigning the mobile unit to the tracking area based on the information indicative of the tracking area associated with a mobile unit.

24. The method of claim 15, comprising providing a paging message intended for the mobile unit to at least one of the base stations associated with the tracking area.

25. The method of claim 15, comprising providing information indicative of at least one of a threshold value and a timer duration.
